(19) United States
(12) Patent Application Publication
(10) Pub. No.: US 2005/0223560 A1
(43) Pub. Date: Oct. 13, 2005

(54) Dry shaver for variable heights of cut

(76) Inventor: P. J. Walls, Dublin (IE)

Correspondence Address: Rossi & Associates, PO Box 826, Ashburn, VA, 20146-0826, US

(21) Appl. No.: 10/467,689

(22) PCT Filed: Feb. 1, 2002
(86) PCT No.: PCT/IE02/00014

§ 371 Date: Jan. 25, 2005

(30) Foreign Application Priority Data
Feb. 8, 2001 (EP) 01200453.7

(51) Int. Cl. B26B 19/00

(52) U.S. Cl. 30/43.1; 30/43.2

(57) ABSTRACT

A dry shaver (11) has a single cutter blade (15) and a single cooperating shear blade (17). The shear blade (17) is an elongate flexible foil, the thickness of which is different at different regions (21, 22) along the elongate extent of the foil (17). The foil (17) is mounted (27) for displacement in its elongate direction so that a foil region (21, 22) of a particular thickness may be selectively aligned with the cutter blade (15). The spacing between a skin engaging surface of the shear blade (17) and the opposite face of the shear blade (17) which cooperates with the cutter blade (15) is thus selectively variable. In a further embodiment, the dry shaver is of the rotary type and has a plurality of interchangeable shear blades of different thicknesses. In a still further embodiment, a rotary dry shaver has a mechanism for varying the spacing between the outer surface of a cover member overlying a shear blade and a cooperating rotary cutter blade.

### BACKGROUND OF THE INVENTION

1. Field of the Invention

This invention relates to dry shavers having a cutter blade and a cooperating shear blade arrangement. The invention relates at least both to electric dry shavers of the type having a reciprocating cutter and a shear blade arrangement in the form of a perforated foil with a plurality of perforations, and also to dry shavers of the type having a rotary cutter member or blade underlying an external shear member provided with apertures for entry of the hairs to be cut.

The history of shaving to date has been the search for the ever closer shave. In effectuating a close shave, certain skin and hair types encounter the problem of an inflammation due to re-entry into the skin of too short cut (tangentially exiting) hairs. It is an aim of the present invention to prevent or protect against this by purposefully cutting the hair long at a sufficient distance from the skin surface so as to prevent any possible re-entry into the skin of the close cut hairs. The invention is thus directed at cutting the hairs long enough away from the skin surface to prevent their re-entry.

In shaving close, certain skin and hair types thus experience or develop inflammation due to re-entry into the skin of the closely shaved hairs. It is therefore a purpose of the present invention both to allow for a normal close shave and to allow also for a cut of hair at some distance from the skin surface, the distance from the skin surface being sufficient so as to prevent re-entry of the cut hairs into the skin.

2. Description of the Prior Art

GB-A-1,569,096 describes a dry shaver having a flexible perforated shear foil supported in a frame and a reciprocatable cutter which cooperates with the shear foil. The shear foil is supported in an arched position between two side members of the frame and a cutter blade or shear head is pressed against the interior side of the shear foil by means of a spring. Similar such units are described in U.S. Pat. No. 3,729,821 and in a diversity of other patent documents. The cutter blade may be mounted for reciprocation in a direction substantially parallel to the axis of curvature of the shear blade foil, or alternatively, the cutter blade may be driven in oscillatory motion about this axis.

In a particular example of the shear foil type dry shaver, there is described in U.S. Pat. No. 3,694,916 an arrangement in which a reciprocatable cutter cooperates with a shearing blade having at least two shearing fields of different perforations. The shearing blade or foil is movable to bring a selected shearing field into the cooperating shearing disposition with the cutter blade. The arrangement enables a field of perforations which is most suitable for a particular type of skin to be selected but makes no reference to cutting hair at different lengths. The selected field of perforations is changed, but not the depth or height of cut.

A diversity of rotary cutter shavers are also known, and reference may be directed inter alia to U.S. Pat. No. 5,007,168, EP-A1-0,241,082, and EP-A1-0,484,795, all of which embody the rotary principle already indicated above.

In WO-A-97/45235, there is described a rotary shaving apparatus in which radially directed hair entry apertures are of either broad or narrow dimension in the circumferential direction. The thickness of the shear blade in which the hair entry apertures are defined varies, depending on the dimension of the hair entry apertures. The shear blade is of greater thickness in a region thereof containing broad hair entry apertures than it is in a region containing narrow hair entry apertures. Thus the blade has a wavy or undulating configuration in the circumferential direction, with the depth or thickness of the blade increasing or reducing as between broad hair aperture entry regions and narrow hair entry aperture regions. The purpose of the arrangement is said to be to enable both short and long hairs to be caught and severed effectively with the end result of a close shave, while avoiding, as far as possible, irritation of the skin.

### BRIEF SUMMARY OF THE INVENTION

It is a general object of the invention to provide a dry shaver unit directed to overcoming the inflammation problems discussed hereinabove.

According to the invention in a first and most general aspect, there is provided a dry shaver unit comprising at least one cutter blade and a cooperating shear blade arrangement in which provision is made for the spacing between a skin-engaging surface of the shaver unit and regions of the shear blade arrangement which cooperate with the cutter blade to be increased as compared with the spacing required to achieve a “close shave”.

It is a particular object of the present invention to provide a dry shaver in which the depth of cut is variable, so that hair to be cut may be left at a variable length over certain areas of the skin as required, in order inter alia to avoid the development of a shaving rash due to re-entry into the skin of too-short tangentially cut hairs exiting the skin at an acute angle.

According to the invention in a first specific aspect, there is therefore provided a dry shaver unit wherein different spacings between a skin-engaging surface of the shaver unit and regions of a shear blade arrangement which cooperate with a cutter blade are selectively available.

In a particular embodiment of dry shaver according to the invention, a single cutter blade cooperates with a single shear blade and the spacing between a skin engaging surface of the shear blade and the opposite face of the shear blade which cooperates with the cutter blade (i.e. the cutter blade surface or side of the shear blade) is selectively variable. In a favoured construction, the shear blade is an elongate flexible foil, the thickness of which is different at different regions along the elongate extent of the foil, and the foil is mounted for displacement in its elongate direction so that a foil region of a particular thickness may be selectively aligned with the cutter blade. The foil may vary in thickness in a substantially continuous manner over its elongate extent from a minimum thickness portion to a maximum thickness portion, or alternatively the foil may comprise a sequence of foil portions, each of which has a different thickness, the foil portions being flexibly interconnected with one another. A control member is suitably attached to the foil, the control member being displaceable in selective manner in the elongate direction of the foil. In a preferred arrangement, the control member comprises a control stud extending through a slot defined in a wall portion of the shaver, an external region of the control stud being manually engageable to effect displacement of the foil in its elongate direction. The foil may be retained in a particular selected position such as by frictional interaction between control stud and slot.

In an alternative arrangement, opposite elongate ends of the foil may be engaged at opposite ends of a rocking mechanism, displacement of the foil in its elongate direction being effected by rocking displacement of the rocking mechanism.

In a further aspect of the invention, there is provided a dry shaver in which said at least one cutter blade is a rotary cutter blade, the or each cutter blade having an overlying cooperating shear blade, wherein the spacing between the skin engaging surface of the shear blade and the opposite face thereof for cooperation with the cutter blade is increased as compared with the spacing required to achieve a “close shave”.

In a particular rotary construction of dry shaver according to the invention, the shaver is provided with a plurality of shear blades and the spacing between the skin engaging surface of one of the shear blades and the opposite face thereof for cooperation with an associated cutter blade (i.e. the cutter blade surface or side of the shear blade) is different from the spacing between the corresponding surface and opposite face of at least one other of the plurality of shear blades. Thus, for example, one of the shear blades may provide for a close shave and another shear blade for a less close shave For a shaver having a head with two or three blades used simultaneously, the invention may provide two or more sets of blades for use on the head, one of the sets of blades providing for a close shave and another of the sets of blades enabling a less close shave. It will be appreciated that more than two such sets may be provided, i, a third set for example facilitating a shave intermediate between a close shave and a long shave.

In a variant of this aspect of the invention, a dry shaver may comprise at least two rotary cutter blades, wherein each rotary cutter blade has a general axis of symmetry and the axis of symmetry of at least one rotary cutter blade is oriented differently from the axis of symmetry of at least one other rotary cutter blade with respect to a generally longitudinal axis of the dry shaver as whole, so that only one of at said least one rotary cutter blade and said at least one other rotary cutter blade can be used for shaving purposes at one time. Thus in this variant of the invention, the shaver is provided with two or more shaving head regions, each of which faces away from the general longitudinal axis of the unit in a different direction, so that only one of the head regions can be used at a time. Each head region may have two or more blades and as previously indicated, the shaver unit may be provided with multiple sets of blades so that one head region may be set up for a close shave and another head region set up for a less close shave. Because this embodiment of the invention has two or more head regions facing in different directions, the unit may be set up to enable the user to choose a close shave or a less close shave simply by applying the appropriate head region to the skin. In yet another variant of this aspect of the invention, the shaver unit may have three head regions, each of which faces in a different direction away from the general longitudinal axis of the unit, the three head regions or head assemblies being spaced apart by substantially one hundred and twenty degrees about this longitudinal axis.

In any variant of dry shaver according to the rotary aspect of the invention, the shaver unit may be provided in combination with at least two cutting head assemblies, each head assembly having at least one cutter blade and the or each cutter blade having a respective overlying cooperating shear blade, wherein the or each shear blade of one of the head assemblies has a spacing between its skin engaging surface and its opposite face which is the same for the or all of the shear blade(s) of said one of the head assemblies but is different from the corresponding spacing for the or all of the shear blade(s) of the other of the head assemblies, and the head assemblies are interchangeably mountable on a body portion of the dry shaver. In addition to being provided with two or more interchangeable head assemblies, multiple sets of blades providing for different depths of cut may also be included in the shaver kit. Thus one head may be set up with blades suitable for a close shave, and another of the head assemblies set up for the less close shave. The user wishing to change from one class of shave to the other simply exchanges the heads appropriately. Thus the invention extends to a shaver kit including a shaver body unit and two or more head assemblies interchangeably associatable with the body unit which contains the drive features of the shaver, and the kit may optionally include multiple blade assemblies for individual assocation as required with any of the head assemblies. Extensive flexibility of use is thus available, either by interchanging a head assembly or set of blades as required, or, for the arrangement provided with multiple head regions or head assemblies disposed in different angular orientations, merely by applying the appropriate head region to the skin, with optional advance mounting of blades of an appropriate depth of cut on the selected head region before use, as may be required.

The dry shaver of the invention, in any of the rotary embodiments, may be provided in combination with a plurality of blade assemblies, each blade assembly comprising a cutter blade and an overlying cooperating shear blade, wherein the blade assemblies are interchangeably mountable on the dry shaver. Thus, as already indicated, in a dry shaver kit according to this aspect of the invention and comprising any of the foregoing features of the invention, the kit may include multiple sets of blade assemblies, interchangeably mountable on the dry shaver, so that the user may select an appropriate depth of cut by mounting a blade or blades suitable for that depth of cut on a head assembly of the dry shaver unit or kit, as required.

According to yet another aspect of the invention in its rotary configuration, there is provided a dry shaver comprising at least one rotary cutter blade, wherein the spacing between a skin-engaging surface of the dry shaver and the cutter blade is selectively variable and a value may be selected for said spacing which is increased as compared with the spacing required to achieve a “close shave” Thus in this variant of the invention, depth of cut is available in an infinitely variable manner similar to that afforded by the foil embodiment of the invention, but without necessitating either individual blade assemblies to be exchanged or the head assembly as a whole to be swapped for an alternative head assembly. In this aspect, the invention thus offers the immediately selectively variable depth of cut of the foil embodiment combined with features of the rotary construction.

In a particular construction of the invention in this additional aspect, the shaver comprises at least one rotary cutter blade, the or each of which has an overlying cooperating shear blade and a cover member overlying the shear blade, the spacing between a skin engaging surface of the cover member and the face of the shear blade which cooperates with the cutter blade being variable. In this arrangement, the shaver may include a displacement mechanism for effecting controlled movement of a shear blade and cutter blade assembly towards and away from the cover member.

Thus in these foregoing embodiments, the advantages of immediate or direct, controlled substantially infinitely variable adjustment of the depth of cut within predetermined limits is achieved for a rotary shaving unit also.

The invention also extends to a blade assembly for a dry shaver comprising a rotary cutter blade and a cooperating shear blade, wherein the spacing between a skin engaging surface of the shear blade and the opposite face thereof for cooperation with the cutter blade is increased as compared with the spacing required to achieve a “close shave”.

The invention likewise additionally encompasses a head assembly for a dry shaver, comprising at least one rotary cutter blade, the or each cutter blade having an overlying cooperating shear blade, wherein the spacing between the skin engaging surface of the shear blade and the opposite face thereof for cooperation with the cutter blade is increased as compared with the spacing required to achieve a “close shave”.

Thus the invention embraces in addition blade assemblies and head assemblies incorporating the features of the invention as independent units, whether in combination with a dry shaver or as entirely separate assemblies. The invention likewise extends to any kit of parts comprising a dry shaver drive unit, one or more head assemblies, and/or one or more blade assemblies, provided in combination or in any commercial association, in so far as such units incorporate the features of the invention or together cooperate in defining equipment lying within the scope of the invention.

The invention also extends to a dry shaver substantially as described herein with reference to and as shown in any one or more of the accompanying drawings.

### BRIEF DESCRIPTION OF THE DRAWINGS

A number of embodiments of the invention will now be described having regard to the accompanying drawings in which:

FIG. 1 is a diagrammatic representation of a portion of human skin, in the region of the surface of the skin, in section, showing inner and outer skin layers and hair growth, and representing also a particular condition in which an individual's body hair is subject to growth in a manner more horizontal than vertical,

FIG. 2 is a side sectional view of an adjustable foil blade in a dry shaver in accordance with the present invention,

FIG. 3 is a pictorial representation of an embodiment of foil blade suitable for a dry shaver according to the invention,

FIG. 4 is a side sectional representation of an alternative manner of adjustable foil blade mounting for a dry shaver in accordance with the present invention,

FIG. 5 is a diagrammatic view in section through a shear blade of the kind illustrated in FIGS. 2 to 4, showing a known variant in which a sharp cutting edge is defined by a downturn around the periphery of the hair entry openings in the foil,

FIG. 6 is a pictorial view of a rotary blade razor of known construction, to which the present invention may be applied in an alternative embodiment,

FIG. 7 is a simplified pictorial view of an alternative rotary blade razor, having two blades as compared with the three-bladed configuration of FIG. 6, to which again the present invention may be applied in an alternative embodiment,

FIG. 8 is a side sectional view of a shear blade of conventional construction for use in the shaver of FIG. 6 or that of FIG. 7,

FIG. 9 is a side sectional view of a modified shear blade for rotary embodiment of dry shaver in accordance with the present invention,

FIG. 10 is a pictorial representation from beneath of a shaver head construction providing for adjustability of the spacing between the cutting blades and the skin surface in a twin-bladed embodiment of dry shaver of a kind similar to that shown in FIG. 6, and

FIG. 11 is a longitudinal sectional view on the longitudinal centre line of the arrangement of FIG. 10.

### DETAILED DESCRIPTION OF THE DRAWINGS

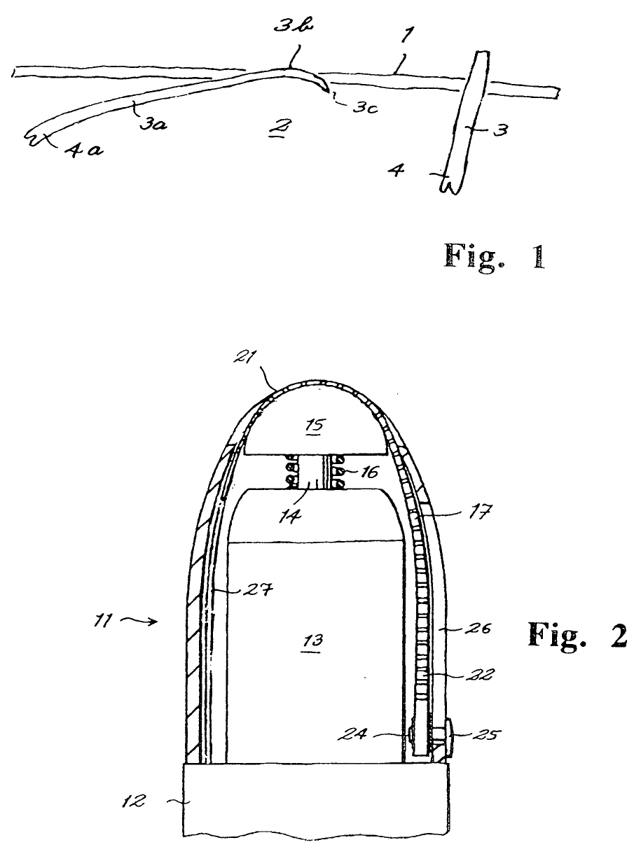

FIG. 1 is a representation in sectional view of a portion of the surface of the skin of an individual. As shown in FIG. 1, the outer layer 1 of the skin is underlaid by an inner layer 2. Hairs 3 and 3a grow outwardly through the skin from respective root regions 4 and 4a and emerge through the outer layer 1 of the skin. In the normal way, as indicated by hair 3, a hair should emerge from the skin outer layer I and extend outwardly above the skin surface substantially at right angles to the skin surface. Depending on the region of the skin surface in question, certain hairs such as that designated by reference 3a in FIG. 1 do not grow upwardly substantially perpendicularly or vertically with respect to the skin surface but run tangentially close to but underneath the skin surface. Eventually, such a hair emerges from the skin surface, as indicated at reference 3b, but in a highly tangential manner. If an individual suffering from such tangential hair growth wishes to effect a close shave and cuts the hair relatively close to the skin outer surface, a condition develops in which the sharp edge of the cut hair burrows back beneath the surface of the skin, as indicated at reference 3c, rather than emerging from the skin and growing externally in the normal manner. Such ingrowth occurs if the sharp, cut edge of the hair becomes engaged or caught beneath the surface of the outer skin layer 1. If growth then continues with the hair 3 running into and under the skin, the inevitable result is some kind of inflammation.

It is therefore preferable to prevent the development of any such inflammation and the present invention addresses this problem. The concept underlying the avoidance of such skin conditions is to cut the hair slightly above the surface of the skin in areas of the body surface where the possibility of such ingrowing conditions arising is likely to be greatest. The advantages of its being possible to cut hair in accordance with the principles of the present invention are not however limited only to skin conditions such as that illustrated with reference to FIG. 1, but the invention is applicable to all skin circumstances where shaving bumps or other skin eruptions or imperfections militate against an excessively close shave. The invention provides the user of a dry shaver with the ability to selectively cut body hair either tightly or to a greater length, depending on the region of the skin in question, i.e. the area currently being shaved.

An embodiment of the invention applicable to a foil type dry shaver is shown in FIG. 2. A removable shaver head portion 11 is mounted on a shaver body portion 12. The head 11 is seated on the body portion 12 to enclose the upper or drive portion 13 of the shaver body portion 12 in conventional manner. A generally conventional drive arrangement is applied such as by drive member 14 to an outwardly curved or convex cutter blade 15 to provide either reciprocating movement in the axial direction of the curved cutter blade 15, or alternatively oscillatory or circumferential motion about this axis. A spring arrangement such as a helical spring 16 urges the curved displaceable cutter blade 15 against the inner surface of a cooperating perforated foil blade 17, which serves as a substantially stationary shear member for the movable blade cutter 15 under shaving conditions, i.e. foil blade 17 remains substantially static with respect to cutter blade 15 during an actual shaving operation.

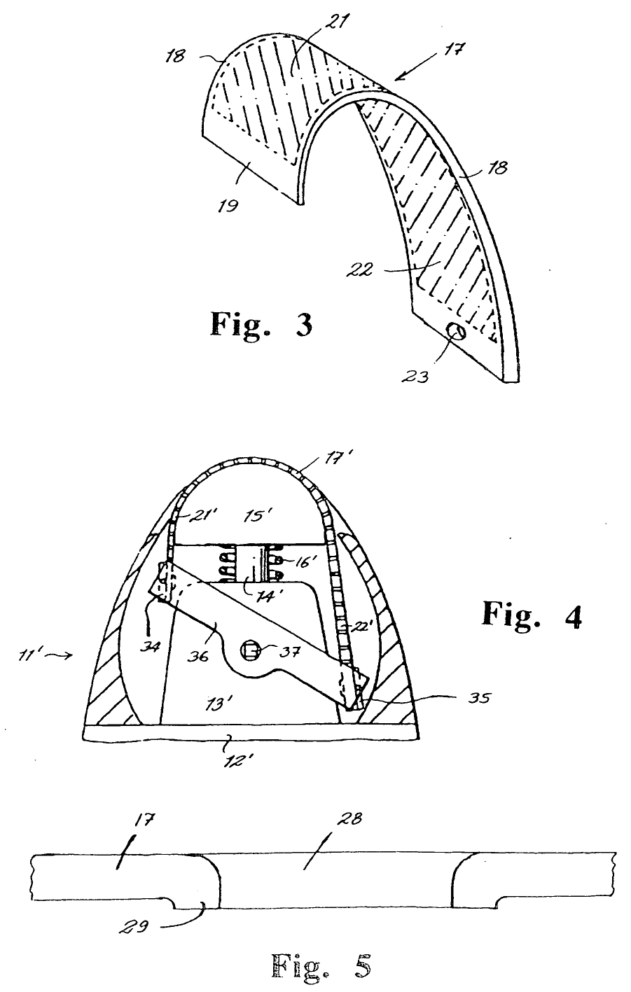

The perforated foil blade 17 is received in a bent-over configuration within an open top region of the shaver head 11. The foil blade 17 is received and accommodated in curved guide grooves extending along opposite inner walls of the shaver head 11. One such guide groove is indicated by reference 27. It is a particular feature of the invention that this perforated foil which serves as the shearing blade 17 has a thickness which varies along the length of the foil, as shown in FIGS. 2 and 3. It is also possible for the size, i.e. the width or breadth of the hair-entry apertures, also their configuration, to vary with the thickness of the foil, e.g. the apertures being narrow where the foil is thin and wider where the foil is thick. Wide and narrow apertures may also be intermingled.

Referring now also to FIG. 3 in particular, there is shown a favoured embodiment of the perforated foil blade or shear cutter 17, formed as an integral unit, in which the perforated central region of the blade 17, designated by cross-hatching, is surrounded by side 18 and end 19 members or blade regions, which are unperforated and define therefore lateral members and end or cross-members of the blade structure. The blade 17 has a thinner region 21 towards one axial end in its generally longitudinal direction and a thicker region 22 towards its other axial end. In the region of the thicker end 22, an aperture 23 is provided through which a fastener 24, FIG. 2, enables the blade 17 according to the invention to be coupled to an operating or control button 25, which is displaceable on the exterior of the shaver head 11 in the longitudinal direction of the blade 17 and is guided by a guide slot 26 provided in the housing of the shaver head 11.

In an alternative arrangement (not illustrated), the flexible foil blade may be supported in a separate frame structure having end and side members. The end edges of the foil blade are fastened to the end bars of the frame structure and guiding grooves provided in opposite inner walls of the shearing or shaver head housing again serve to guide the lateral or side members of the frame, which are flexible, in similar manner to the flexible side edges of the integral blade structure of FIG. 3. The perforated foil blade again varies in thickness along its longitudinal extent from one end edge to the other. In either arrangement, integral or frame-mounted, a foil portion of the desired thickness is selectively brought into a cutting disposition with respect to the cutter blade 15 by controlled sliding movement of the foil blade 17 in its longitudinal direction This is facilitated by the external button arrangement 25 which runs in the guide slot 26 along the surface of the shaver unit head 11. In this manner, a required depth of cut may be readily chosen and speedily varied in controlled manner as required by the user. Retention of a particular selected position of the foil 17 may be achieved by cooperating frictional interaction between button 25 and slot 26, e.g. by button 25 and connection or fastener portion 24 defining a “nip” or light gripping engagement between inner and outer face regions of head 11 bordering slot 26.

In order to provide guidance for the side edges 1a of the variable thickness shear blade 17, the guide grooves 27 in the shaver head have a dimension between the opposite side surfaces of the guiding groove 27 which may vary but is always appropriate for the thickness dimension of the blade 17 in the relevant region. In order to ensure that the thinner regions of the foil 17 are appropriately guided, the guide grooves 27 then may be provided, if necessary, with appropriate resilient means, such as leaf springs or the like, to urge the foil 17 towards an appropriate side face of the groove 27, and thereby take up as it were any possible intervening redundant space between a thinner portion of the foil 17 and the opposite side wall of the guiding groove 27. Alternatively, in either embodiment of the foil, the side edges 18 or the corresponding side frame members may be arranged to have a uniform thickness throughout the longitudinal extent of the shear blade or foil 17, so that the provision of resilient means in the guide grooves is not then required.

The installed foil blade 17 is stretched as it were over the curved surface of cutter blade 15 at the cutting end of the shaver head unit 11. The foil blade 17 is tensioned in the outward direction by the spring-loading (16), underlying cutter blade 15, which also serves for holding it in place.

In the embodiment as shown in FIGS. 2 and 3 of a foil 17 suitable for use with the invention, variation in thickness is substantially continuous from one end of the foil 17 to the other, from a minimum thickness portion 21 at a first end, to a maximum thickness region 22 at the other end. In this way, a substantially infinite variation of thickness can be selected between the two extremes. The side edges of the foil 18 may however be of constant or uniform thickness over the entire longitudinal extent of the blade 17, depending on the properties of the material selected for the foil 17, as already discussed above, or the side frame members, in a framed embodiment, may be likewise of uniform thickness.

In an alternative embodiment (not illustrated), the foil may have a number of sections, each of which is of a different thickness and configuration, and each section being connected to an adjacent section by for example a hinge portion or by any other suitable manner of interconnection. The sections are therefore joined for flexure, i.e. to be flexible when the continuous foil structure is formed from the individual sections, and define a flexible continuous foil. The sections may for example be joined by being bonded to one another in some suitable manner. In such an embodiment, the foil has therefore a number of discrete portions or sections, each of which has its own individual thickness, so that a corresponding depth of cut applies. Again, an appropriate depth of cut is readily selected in controlled manner by sliding movement of the foil to the requisite location. Variable aperture size and configuration and/or intermingled sizes and configurations of aperture in different regions of the foil may also be provided in this constructional variant.

In an alternative mounting arrangement shown in FIG. 4, the structure and arrangement of the shaver head housing 11′ and shaver body 12′, as well as the cutter 15′ structure, correspond to the arrangements of FIG. 2, features similar to those of FIG. 2 being designated by use of the same reference numerals with the addition of an apostrophe. However, in order to secure longitudinal displacement of the perforated foil blade 17′, the sliding button-controlled arrangement of FIG. 2 is replaced by a pivotal structure, in which end edges of the foil blade 17′ are connected 34, 35 to respective ends of a pivotally mounted rocker mechanism 36 arranged 37 for rocking movement within the shaver head housing 11′. Any suitable means may be provided for connecting the foil blade 17′ to cross-bar portions of the rocker lever structure 36, such as fasteners 34, 35. Likewise, any suitable arrangement may be provided to secure controlled pivoting 37 of the rocking blade mounting frame or structure 36, for example a lever arm or knob at the end of a pivot axis mounting 37, or alternatively, displacement may be effected merely by sliding the perforated foil blade 17′ over the surface of the cutter blade 15′, using the fingers. In either arrangement, the rocker member 36 is suitably pivotally mounted by way of pins or a shaft 37, bearingly accommodated on the interior of the side walls of the head housing 11′. Retention of the foil blade 17′ in a particular longitudinal disposition with respect to the blade 15′ may again be achieved such as by suitable frictional cooperation or interaction between pivot mounting 37 and the bearing features by which pivot axis or shaft 37 is accommodated in the walls of the head housing 11′, or by any other suitable equivalent arrangement, such as for example a locking screw or the like associated with a pivot position adjusting knob. A multiplicity of possible arrangements will be apparent for achieving substantial locking of the foil 17′ in a particular selected shaving disposition by securing the rocker arm or lever 36 in a particular pivoted disposition following selective controlled displacement of the foil to align a designated region of the foil with the cutter blade.

In any variant of the variable thickness foil embodiment of the invention, the regions of different foil thickness may be differentiated from one another such as by for example colour coding.

FIG. 5 shows detail of a feature by which an especially effective cutting or shearing action may be achieved for a foil shear blade. In the arrangement shown, in the formation of the hair entry openings 28 in the foil structure shear blade 17, the periphery of each entry opening 28 is turned slightly downwards, so that the peripheral region 29 surrounding the opening 28 protrudes below the general level of the remainder of the underside of the foil shear blade 17 to define, as it were, a lip. An especially effective shearing type action is then achieved when the cutter blade 15 interacts with this peripheral region 29 of the foil shear blade 17 surrounding the hair entry opening 28.

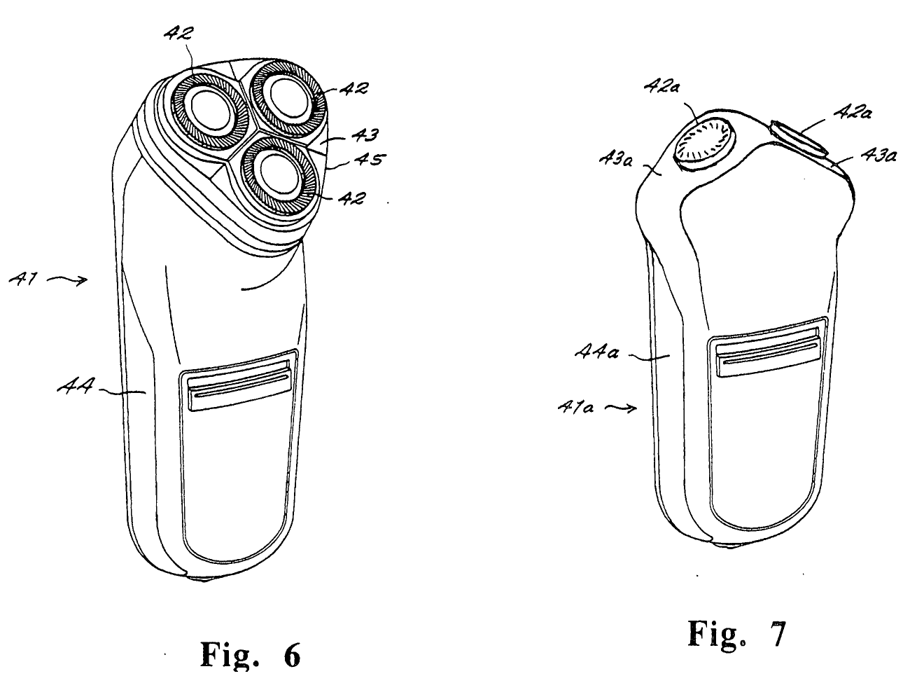

Referring now to FIG. 6, an embodiment of the invention applicable to a rotary type dry shaver will now be described. In a typical construction, a rotary dry shaver 41 may have a number of cutter units 42, typically three as shown in the drawing, or alternatively two units 42, in each case located at the cutting end face 43 of the shaver body 44. The cutting drive and mounting arrangements of this variant of the invention are generally in accordance with substantially conventional arrangements well-known in the industry and only the particular deviations from such constructions required by the present invention are now described in detail. In such constructions, each cutter unit has an external or shear blade, which has hair entry apertures or slits and is underlaid, in the assembled condition, by a rotating cutter blade, which severs hairs extending into the cutting region of the cutter blade through the slits or perforations (apertures) of the shear blade. According to the invention, each of the rotary blade assemblies 42 is equipped with a shearing blade unit having a particular thickness or depth dimension of the hair entry slits or perforations, so as to provide for a corresponding depth of cut. Preferably, each blade assembly provides the same depth of cut. In a favoured arrangement according to the invention, two or more interchangeable head assemblies may be provided, each having blades providing a particular depth of cut, e.g. “close” shave or “long” cut, so that a user can choose a head assembly providing for a tight cut or a head assembly providing for a less close shave.

Thus the invention provides a shaving kit incorporating a dry shaver body unit which includes drive features, one or more head assemblies which are interchangeable with the drive portion or body of the shaver and two or more sets of blades which can be interchangeably associated with any of the head assemblies. In this manner, a user may set up one head assembly with each blade providing for a close shave and a second head assembly on which each blade allows a more generous cut. For regions of the skin where the close shave is desired, the user applies the close shave blades by mounting the appropriate head assembly on the drive portion of the shaver unit. Where it is necessary or desirable to apply a less close shave, the user then exchanges the close shave head assembly for that enabling the less close shave.

Referring now to FIG. 7, there is shown, in pictorial view, a rotary shaver having two cutter heads, each of which is angled away from the longitudinal axis of the cutter unit, so that only one head can be used at any given time. Each cutter head is located on an angled end face region of the shaver, so that each cutter can be engaged individually against the skin, without engagement of the other cutter, located on the other angled face. In a variant, each angled face could carry two blades, in a two-bladed cutter head assembly. The shaver would then have two twin-blade head assemblies, one on each angled cutter face. In a shaver of this kind in accordance with the invention, all cutter blades and each head assembly are interchangeable with other blade units or head assemblies respectively.

As already indicated, the shaver unit in this embodiment also may be provided as a kit, with for example two or more detachable and interchangeable head assemblies and two or more sets of blades providing for different depths of cut. The user sets up one of the head assemblies with blades suitable for a close shave and the other head assembly for a less close shave. The two head assemblies can be mounted on the base portion of the shaver unit for use in the manner already described, namely close shave where feasible and less close shave where necessary. Additional head assemblies may also be included in the kit of parts as also may additional sets of blades providing for still different depths of cut. In a further variant of the arrangement provided in FIG. 7, the base unit may accommodate three heads, each angled outwardly from the generally longitudinal axis of the base portion which also defines the gripping or handle portion of the unit, so that the three head regions or head assembly mounting portions are spaced equidistantly around this axis substantially at 120° from each other. The unit may then be set up to provide for three different depths of cut and the user applies the appropriate depth of cut by rotating the unit so that the selected head region can be applied to the skin. In this manner, particular ease of use is facilitated with maximum interchangeability and flexibility as regards depths of cut, by the diverse options available for interchange or exchange of head assemblies and blade assemblies.

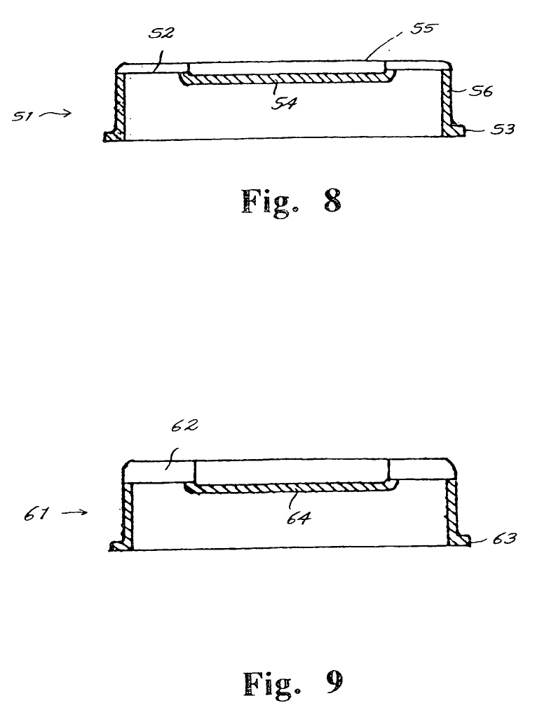

Referring now to FIG. 8, which shows an external cutting member or shear blade 51 of generally conventional configuration, a head 42 equipped with this type of shear blade 51 may be regarded as providing a minimum depth of cut, for a tight shave. As shown in this drawing, the cutting member 51, which is in the general shape of a top-hat, or an inverted cup, has a series of generally radially-oriented, optionally skewed, hair entry slits or apertures 52, in an outwardly-directed generally disc-shaped region 55 of the blade 51, which is upwardly-oriented when mounted on the cutting unit 42. The outer surface of this disc-shaped region 55 of cutting member 51 comes into contact with the skin during a shaving operation. From the side of this disc-shaped region 55 opposite to the skin-engaging surface, at the periphery of the disc, a generally annular peripheral wall portion 56 extends (downwardly in the mounted condition on cutting unit 42) to terminate in an externally-directed holding flange 53, by which the shear blade is secured in position on the shaver cutting unit 42. Centrally of the generally disc-shaped region 55, radially inward of the slits 52, there is a provided a central dished portion 54, which is set back from the skin-engaging surface defined by the outer face of region 55 at the slots 52.

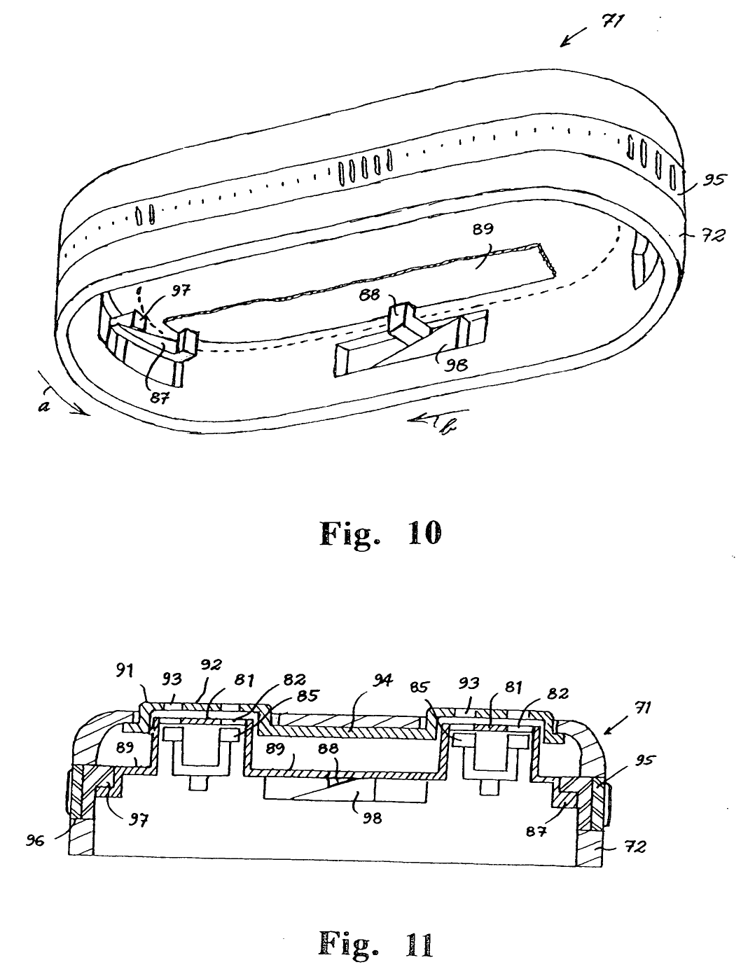

In order to provide for a more generous shave, in other words a less tight or close shave leaving a longer beard length, at least one other cutter 61 is provided, in the form of a shear blade of greater thickness, as shown in FIG. 9, so that the depth of cut is greater when that particular cutter is applied to the face. The general construction of cutter or shear blade 61 is similar to blade 51, so that blades 51 and 61 are interchangeable on the dry shaver of FIG. 6 or that of FIG. 7. In the shaver of FIG. 6, preferably all of the blades provide for a close shave or all of the blades provide for a less close shave. However, in the two head shaver of FIG. 7 or in a three head variant of this design, the blade or blades of one of the heads may provide for a close shave and the blades of the other or another of the heads provide for a less close shave, so that different regions of the face may be shaved according to need, either to provide a smooth close shave or a less tight cut. Thus in the FIG. 7 variant, a tight shave or a less close shave may be achieved without requiring the user to change either a blade assembly or a head assembly, although this option may also be present within the scope of the invention.

Again as already discussed, the invention in this aspect offers extensive flexibility of use, not only by selecting the appropriate head region to be applied to the skin in the two-headed arrangement of FIG. 7 or the alternative three-headed variant discussed previously, but further flexibility and interchangeability is facilitated by the inclusion of additional head assemblies and/or additional blade assemblies in a shaver kit provided in accordance with the principles of the is invention.

The only dimensional difference between the blades 51 and 61 is in the thickness of the blade in the outer skin-engaging portion. Slits 62, flange 63 and central dished region 64 correspond to portions 52, 53 and 54 of the standard cutter 51 of FIG. 8, but the slits 62 are substantially greater in depth than the slits 52 of blade 51. Accordingly, when this shear blade 61 is applied to the face, the hairs are cut at a longer length than in the case of the blade 51. In use of this embodiment of the invention, the second cutter 61 (FIG. 9) is to be applied to skin areas where the cut is not to be too tight, so as to avoid the dermatological and other skin problems previously identified, while the first cutter 51 (FIG. 8) will be used to achieve a tight shave and good appearance where this does not create any skin hazard or potential damage.

Yet another cutter unit may provide another thickness of shear blade, so that a still further depth of cut may be effected, as required. Thus, at least two possible depths of cut are selectively available to the user during operation of the dry shaver. In the three-blade shaver of FIG. 6, completely separate head units 45 may be provided for, first of all, a standard cut, and secondly and alternatively, for situations where a less tight cut is required, this second alternative head having all of the shear blades dimensioned to provide greater spacing from the skin surface according to the arrangement of FIG. 9, while the first head has shear blades in accordance with FIG. 8. Referring again to FIG. 6, head unit 45 is separable from the body 44 of the shaver unit, so that the entire head structure may thus be removed and exchanged for one providing for such a different depth of cut by virtue of the shear blades of all of the cutting units of the alternative head portion 45 being provided with shear blades of different slit or aperture depth from the depth applicable to a standard cut. Again in this variant, at least two possible depths of cut are then available to the user, simply by head interchange. Thus each head, standard and alternative, has shear blades of uniform cut capability for all blades of that head, but the depth of cut achievable varies as between the heads.

It is known in the rotary shaver art to provide head and blade assemblies that can be readily dismantled for cleaning and maintenance. Any known construction of head or blade assembly of this kind may be applied to the improved blade arrangements and techniques provided by the present invention. In particular, such known constructions may be applied to the interchangeable head assemblies, and/or individual interchangeable blade units, as provided the present invention.

According to the present invention, the dismantling capability of head and blade assemblies is further developed to provide extensive interchangeability on the drive portion of the shaver as between head assemblies on the drive base and blade assemblies on the head assemblies. Thus a rotary shaver in accordance with the invention having a base portion suitable for mounting a single head assembly may be provided as a kit including two head assemblies, each of which has blades enabling a different depth of cut. One head assembly may provide for a close shave and the other head assembly for a less close shave. In addition, further sets of blades or blade assemblies may be provided, so that still different depths of cut may also be enabled by mounting a further alternative set of blades on one of the heads. In a variant of the invention, the base drive unit may accommodate more than one head assembly at the same time. Both head assemblies can be driven simultaneously or selectively by the base drive unit. One of the head assemblies is provided with blades suitable for a close shave and the other with blades suitable for a less close shave. One or other of the head assemblies can then be applied to the skin, depending on the depth of cut required. Yet a further variant of this aspect of the invention provides for the single drive unit to have no less than three head assemblies, all capable of use without requiring demounting of a head assembly and its replacement by an alternative.

In any of the variants of the invention, the system may be provided as a kit of parts, with a single base unit or drive portion and two or three or more head assemblies. Each head assembly may be pre-provided with a set of blades of a particular depth of cut. In addition or alternatively, further blade assemblies may be included in the kit of parts, for interchangeable placement or mounting on any of the head assemblies as may be required. Great flexibility and adaptability in use is thus available in accordance with the principles of the invention. All head assemblies are readily removable from the base drive portion and all blade assemblies are readily removable from the respective head assembly. All sub-assemblies of the system are fully interchangeable, so that any head assembly may be exchanged for any other head assembly and any head assembly may receive any blade assembly. Thus any head portion of the unit may receive mounted on it, blade units of any depth of cut. Thus in a kit of parts according to the invention, the shaver unit is interchangeably associatable with any one of a plurality or multiplicity of heads. Each head may receive a plurality or multiplicity of blades and any blade may be demountably associated with any head. Where angled heads are provided for selective optional use without necessarily exchanging a head for an alternative head unit, the principles of full interchangeability and exchangeability continue to prevail, for ease of advance selection of the particular depth of cut required on any of the angled head regions.

In FIGS. 10 and 11, there is shown an alternative arrangement in which the actual depth of cut for a pair of rotary cutters may be selectively varied during use. The arrangement illustrated is for a two head cutter rotary dry shaver. As shown, there is an inner shear blade structure 81, against the underside of which rotary cutters 85 exercise the cutting action. An outer “dummy” shear blade or external cutter cover arrangement 91 is fixedly mounted in the cutter head 71 for cooperation with the inner shear blade structure 81 to provide for variable spacing between shear blade 81 and outer “dummy” blade or cover 91. The rotary blades 85 are rotatably mounted in known manner and are driven in rotary motion by likewise known drive arrangements (not illustrated).

According to the present invention, the outer “dummy” shear blade or external cutter cover arrangement is a fixed outer perforated cover 91 and is associated with the inner shear blade structure 81 for variable depth of shave or cut, the shear blade structure 81 being mounted to be displaceable towards and away from the outer cover 91. The outer surface 92 of this cover or “dummy” shear blade 91 engages the skin. The cover or spacer head 91 is suitably provided with a series of apertures 93 which may be of relatively large size compared with the slits 82 of the inner shear blade 81, through which apertures 93 the facial hair to be cut passes to be gripped by the perforations or slits 82 of the shear blade 81 and cut in the usual way by the rotary blades 85. The adjustable arrangement enables the shear blade structure 81 to be moved towards and away from the outer cover 91, so that the depth of cut may be selectively varied in controlled manner by the user, depending on the portion of the skin to be shaved. Any one of a diversity of cover-to-blade space-adjusting constructions may be provided to enable the requisite adjustment.

A particularly favoured arrangement for securing this spacing adjustment is shown in FIGS. 10 and 11. In accordance with this arrangement, the dummy external cutter or cover 91 provided with the apertured region 93, which generally overlies the slit region of the shear blade 81, also has a substantially solid central region 94. The general configuration of this additional cover or dummy cutter 91 is therefore broadly similar to that of the actual shear blade 81. Variants are however also possible, to the extent that the cover 91 may be of more open work type construction, with the apertures 93 being defined between a series of radial and circumferential bars, wire type members, or perforated plates, and the central bridging region of “dummy” shear blade 91 is also not an essential structural feature.

In order to secure the inward and outward displaceability of shear blade structure 81 towards and away from the fixed cover 91, FIGS. 10 and 11 provide a control member 95 which is in the form of a peripheral endless band slideable in an external slot 96 in the external side wall 72 of the shaver unit head region 71. At four locations on its endless path, the peripheral band 95 has camming members 97, 98 which cooperate with mating camming members 87, 88 provided on a support structure 89 which either comprises or carries the shear blade 87. Movement of the endless band 95 in the direction indicated by arrow “a” in FIG. 8 causes the shear blade structure 81 to be pulled away from the fixed cover 91 and therefore increases the depth of shave or cut, while movement of the band 95 in the direction indicated by arrow “b” in FIG. 8 produces the converse effect, namely moves the shear blade 81 closer to the fixed blade 91.

A structure of this type is known in itself and is applied in an existing dry shaver arrangement in which the shear blades are mounted in a quasi-floating manner. The structure is such that the rotor blades remain at all times in fixed proximity to the shear blade and travel inwards and outwards with the shear blade, being flexibly coupled to the drive arrangements so that rotation of the cutter blades may be effected at all locations of the shear blade.

In this manner therefore the principles of the invention may be embodied in a dry shaver of the rotary cutter blade type also.

The invention in this embodiment therefore provides substantially infinitely variable selective choice of a preferred depth of cut for any region of the body to be shaved, by varying the displacement between the skin-engaging outer or upper surface 92 of the cover or dummy shear blade 91 and the inner face of the cooperating shear blade 81, where the rotary action of the underlying cutter blades 85 effects actual severance of the hair. Thus according to the present variant of the invention, there is again achieved a dry shaver unit in which a variable depth of cut is selectively available at the user's choice.

The control arrangement 95 shown in FIG. 10 is exemplary only. The arrangements described and proposals indicated herein for shear blade 81 positional control relative to the dummy blade or outer cover 91 are also exemplary only and in no way limit the scope of the invention as defined by the appended claims. In particular, alternative control or drive arrangements for displacing the cover portion relative to the cutter blade may be devised and provided, including, but not limited to, mechanical inversions of the arrangements described and illustrated.

The words “comprises/comprising” and the word “having” when used herein with reference to the present invention are used to specify the presence of stated features, integers, steps or components but does not preclude the presence or addition of one or more other features, integers, steps, components or groups thereof.

1. A dry shaver unit comprising:
at least one cutter blade; and
a cooperating shear blade;
wherein a spacing between a skin-engaging surface of the shaver unit and regions of the shear blade which cooperate with the cutter blade can be varied.

2. A dry shaver unit according to claim 1, wherein different spacings between the skin-engaging surface of the shaver unit and the regions of a shear blade which cooperate with a cutter blade are selectively available.

3. A dry shaver according to claim 2, wherein the shear blade is an elongate flexible foil, the thickness of which is different at different regions along the elongate extent of the elongate flexible foil; and
wherein the elongate flexible foil is mounted for displacement in its elongate direction so that a foil region of a particular thickness may be selectively aligned with the cutter blades whereby a spacing between a skin engaging surface of the shear blade and the opposite face of the shear blade which cooperates with the cutter blade is selectively variable.

4. A dry shaver according to claim 1, wherein said at least one cutter blade is a rotary cutter blade, wherein the cooperating shear blade is located over the rotary cutter blade, and wherein the spacing between the skin engaging surface of the shear blade and the opposite face thereof for cooperation with the cutter blade can be varied.

5. A dry shaver according to claim 4, wherein the shaver is provided with a plurality of shear blades and the spacing between the skin engaging surface of one of the shear blades and the opposite face thereof for cooperation with an associated cutter blade is different from the spacing between the corresponding surface and opposite face of at least one other of the plurality of shear blades.

6. A dry shaver according to claim 5, comprising at least two rotary cutter blades, wherein each rotary cutter blade has a general axis of symmetry and the axis of symmetry of at least one rotary cutter blade is oriented differently from the axis of symmetry of at least one other rotary cutter blade with respect to a generally longitudinal axis of the dry shaver as whole, so that only one of the rotary cutter blades can be used for shaving purposes at one time.

7. A dry shaver according to claim 5 further comprising: at least two cutting head assemblies, each head assembly having at least one cutter blade and a respective overlying cooperating shear blade, wherein a spacing between a skin engaging surface and an opposite face of the shear blade in at least one of the cutting head assemblies is different from a corresponding spacing in other head assemblies, and the head assemblies are interchangeably mountable on a body portion of the dry shaver.

8. A dry shaver according to claim 4 further comprising a plurality of blade assemblies, each blade assembly comprising a cutter blade and an overlying cooperating shear blade, wherein the blade assemblies are interchangeably mountable on the dry shaver.

9. (canceled)

10. A dry shaver according to claim 1, wherein the cutter blade comprises at least one rotary cutter blade, and wherein the cooperating shear blade is located over the rotary cutter blade and comprises a shear blade and cutter blade assembly, and further comprising a cover member overlying the shear blade, and a displacement mechanism for effecting controlled movement of the shear blade and cutter blade assembly towards and away from the cover member, so that the spacing between a skin engaging surface of the cover member and the face of the shear blade which cooperates with the cutter blade is variable.

11. A dry shaver according to claim 2, wherein said at least one cutter blade is a rotary cutter blade, wherein the cooperating shear blade is located over the rotary cutter blade, and wherein the spacing between the skin engaging surface of the shear blade and the opposite face thereof for cooperation with the cutter blade can be varied.

12. A dry shaver according to claim 6 further comprising: at least two cutting head assemblies, each head assembly having at least one cutter blade and a respective overlying cooperating shear blade, wherein a spacing between a skin engaging surface and an opposite face of the shear blade in at least one of the cutting head assemblies is different from a corresponding spacing in other head assemblies, and the head assemblies are interchangeably mountable on a body portion of the dry shaver.

13. A dry shaver according to claim 5 further comprising a plurality of blade assemblies, each blade assembly comprising a cutter blade and an overlying cooperating shear blade, wherein the blade assemblies are interchangeably mountable on the dry shaver.

14. A dry shaver according to claim 6 further comprising a plurality of blade assemblies, each blade assembly comprising a cutter blade and an overlying cooperating shear blade, wherein the blade assemblies are interchangeably mountable on the dry shaver.
